(19) United States
(12) Patent Application Publication
(10) Pub. No.: US 2026/0302768 A1
(43) Pub. Date: Oct. 1, 2026

(54) POWER SUPPLY SYSTEM, MOVING OBJECT, CONTROL METHOD, AND STORAGE MEDIUM

(71) Applicant: HONDA MOTOR CO., LTD., Tokyo (JP)

(72) Inventor: Osamu Sato, Wako-shi (JP)

(21) Appl. No.: 19/629,201

(22) Filed: Mar. 26, 2026

(30) Foreign Application Priority Data
Mar. 27, 2025 (JP) 2025-054466

(51) Int. Cl. H02J 1/08; B64C 29/00; B64D 27/34; H02J 7/68

(52) U.S. Cl. CPC H02J 1/084; B64C 29/00; B64D 27/34; H02J 7/68; B64D 2221/00

(57) ABSTRACT

A power supply system is equipped with a first power storage device connectable in parallel with a power generating device to a first power supply circuit that supplies a DC power output from the electrical power generating device to first load devices, a second power storage device connectable in parallel with the power generating device to the first power supply circuit and having a rated output voltage that is lower than that of the first power storage device, a first voltage conversion device that is capable of boosting the DC power that is supplied from the second power storage device and supplying the same to the first power supply circuit, and a control unit that is capable of supplying a charge from the second power storage device to at least one of the first load device and the power generating device via the first voltage conversion device.

### CROSS-REFERENCE TO RELATED APPLICATIONS

This application is based upon and claims the benefit of priority from Japanese Patent Application No. 2025-054466 filed on Mar. 27, 2025, the contents of which are incorporated herein by reference.

### BACKGROUND OF THE INVENTION

### Field of the Invention

The present disclosure relates to an electrical power supply system, a moving object, a control method, and a storage medium.

### Description of the Related Art

In JP 2023-147342 A, there is disclosed an electrical power supply system that supplies, via an electrical power supply circuit, an electrical power that is output from a main electrical power supply device equipped with a generator. In the electrical power supply system disclosed in JP 2023-147342 A, an auxiliary electrical power source device is connected to the electrical power supply circuit via a disconnection device that includes a pre-charging circuit.

### SUMMARY OF THE INVENTION

There is a long awaited need for a more satisfactory electrical power supply system and the like.

The present invention has the object of solving the aforementioned problem.

A first aspect of the present disclosure is characterized by an electrical power supply system, wherein the electrical power supply system comprises a first electrical power supply circuit that supplies a DC electrical power that is output from an electrical power generating device to a first load device, a first power storage device that is capable of being connected in parallel with the electrical power generating device to the first electrical power supply circuit, a second power storage device having a rated output voltage lower than that of the first power storage device, and a first voltage conversion device that is capable of boosting a DC electrical power that is supplied from the second power storage device and supplying an increased DC electrical power to the first electrical power supply circuit, wherein the electrical power supply system comprises a control unit which, in a state in which the first power storage device is disconnected from the first electrical power supply circuit, by supplying electrical power from the second power storage device to the first electrical power supply circuit via the first voltage conversion device, is capable of executing an charge supply control for supplying an electrical charge to at least one from among the first load device and the electrical power generating device.

Another aspect of the present disclosure is characterized by a moving object comprising the aforementioned electrical power supply system.

Yet another aspect of the present disclosure is characterized by a control method for controlling an electrical power supply system, wherein the electrical power supply system comprises a first electrical power supply circuit that supplies a DC electrical power that is output from an electrical power generating device to a first load device, a first power storage device that is capable of being connected in parallel with the electrical power generating device to the first electrical power supply circuit, a second power storage device having a rated output voltage lower than that of the first power storage device, and a first voltage conversion device that is capable of boosting a DC electrical power that is supplied from the second power storage device and supplying an increased DC electrical power to the first electrical power supply circuit, the control method comprising a charge supply control step of executing, by one or more processors, charge supply control to supply electrical power from the second power storage device to the first electrical power supply circuit via the first voltage conversion device in a state in which the first power storage device is disconnected from the first electrical power supply circuit, thereby supplying an electrical charge to at least one from among the first load device and the electrical power generating device.

Yet another aspect of the present disclosure is characterized by a program in order to execute the aforementioned control method.

Yet another aspect of the present disclosure is characterized by a non-transitory storage medium in which the aforementioned program is stored.

According to the present disclosure, it is possible to provide a more satisfactory electrical power supply system and the like.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a schematic diagram showing a moving object according to one embodiment;

FIG. 2 is a schematic diagram showing a configuration of an electrical power supply system according to the one embodiment;

FIG. 3 is a block diagram showing a configuration of a control device according to the one embodiment;

FIG. 4 is a circuit diagram showing an example of a DC/DC converter;

FIG. 5 is a flowchart showing an example of operations of the electrical power supply system according to the one embodiment;

FIG. 6 is a time chart showing an example of operations of the electrical power supply system according to the one embodiment;

FIG. 7 is a flowchart showing another example of operations of the electrical power supply system according to the one embodiment;

FIG. 8 is a time chart showing another example of operations of the electrical power supply system according to the one embodiment;

FIG. 9 is a schematic diagram showing a configuration of an electrical power supply system according to an exemplary modification of the one embodiment;

FIG. 10 is a flowchart showing an example of operations of the electrical power supply system according to an exemplary modification of the one embodiment; and

FIG. 11 is a time chart showing an example of operations of the electrical power supply system according to an exemplary modification of the one embodiment.

### DETAILED DESCRIPTION OF THE INVENTION

From the viewpoint of improving the cruising distance of a moving object, it is desirable to make the electrical power supply system lighter in weight. Resistors and the like that are provided in a pre-charging circuit have a comparatively large mass. According to the present disclosure described below, it is not necessary to provide a pre-charging circuit including a resistor and the like that has a comparatively large mass, and it is possible to achieve a reduction in weight of the electrical power supply system.

### Embodiments

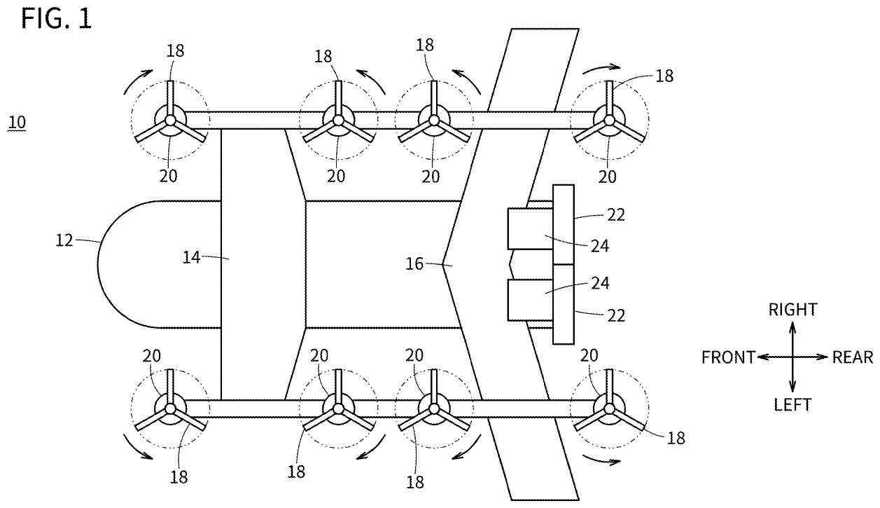

A description will be given with reference to the accompanying drawings concerning an electrical power supply system, a moving object, a control method, a program, and a storage medium according to one embodiment. FIG. 1 is a schematic diagram of the moving object according to the present embodiment. A moving object 10 according to the present embodiment, for example, is an electric vertical takeoff and landing aircraft (eVTOL aircraft), although the moving object is not necessarily limited to this feature. The moving object 10 may be a vehicle, a ship, or the like. The moving object 10 includes a fuselage 12. A cockpit, a cabin, and the like are provided in the fuselage 12. A pilot sits in the cockpit, and controls the moving object 10. Passengers and others board and ride in the cabin. The moving object 10 may be automatically controlled.

The moving object 10 includes a front wing 14 and a rear wing 16. In the case that the moving object 10 moves frontward, a lift is generated respectively on each of the front wing 14 and the rear wing 16.

The moving object 10 is equipped with eight VTOL rotors 18, and two cruise rotors 22. One VTOL electric motor 20 is provided with respect to one of the VTOL rotors 18. The VTOL electric motor 20, for example, is a single three phase motor. One cruise electric motor 24 can be provided with respect to one cruise rotor 22. The cruise electric motor 24, for example, is a dual three phase motor.

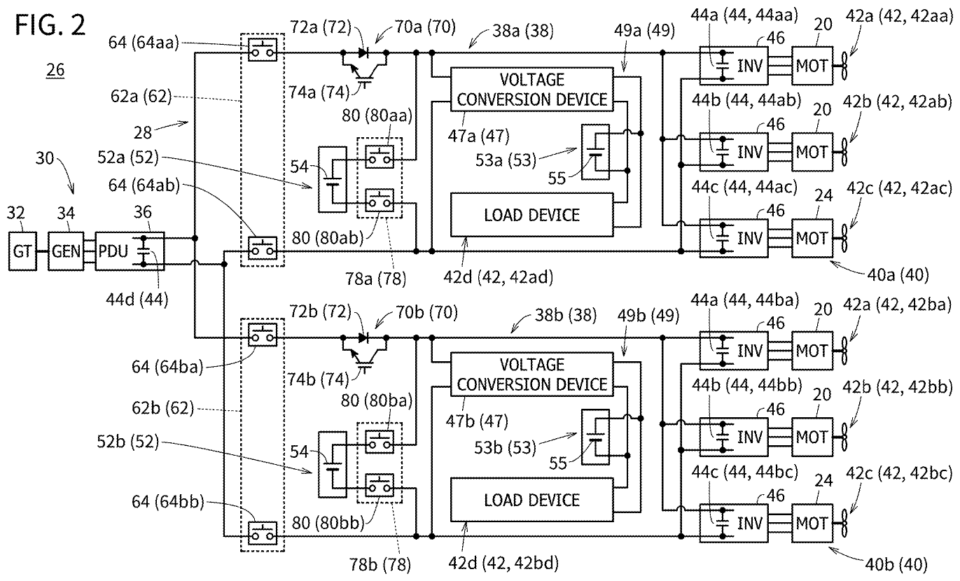

FIG. 2 is a schematic diagram showing a configuration of the electrical power supply system according to the present embodiment. In an electrical power supply system 26, although a plurality of electrical power supply systems 28 may be provided, one of the electrical power supply systems 28 from among a plurality of the electrical power supply systems 28 is shown in the figure. The electrical power supply system 26 is equipped with an electrical power generating device 30 that serves as a main electrical power source. In the electrical power supply system 26, although a plurality of electrical power generating devices 30 may be provided, one electrical power generating device 30 from among a plurality of the electrical power generating devices 30 is shown in the figure.

The electrical power generating device 30 includes an engine (a gas turbine engine, an internal combustion engine) 32, a generator 34, and a power drive unit (hereinafter, referred to as a PDU) 36. An output shaft of the engine 32 is connected to a rotating shaft of the generator 34. The engine 32 serves to drive the generator 34. In accordance with this feature, generation of electrical power is carried out by the generator 34. The PDU 36 converts and outputs an AC electrical power generated by the generator 34 into a DC electrical power. In the case that the engine 32 is started, the PDU 36 converts the DC electrical power that was input to the PDU 36 into a three phase AC electrical power, and outputs the AC electrical power to the generator 34. An generator (starter) 34 is operated by the AC electrical power, and the generator 34 causes the engine 32 to start. A smoothing capacitor 44d may be provided in the electrical power generating device 30. The smoothing capacitor 44d may be provided inside the PDU 36 that is provided in the electrical power generating device 30, although the smoothing capacitor is not necessarily limited to this feature.

The electrical power generating device 30 may include various elements, such as various sensors such as voltage sensors, electrical current sensors or the like, fuses, relays, breakers, diodes, transistors, resistors, coils, capacitors, and the like.

The electrical power supply system 26 may be equipped with a plurality of electrical power supply circuits 38. In the plurality of electrical power supply circuits 38, there may be included an electrical power supply circuit 38a, and an electrical power supply circuit 38b. When the individual electrical power supply circuits are described while distinguishing therebetween, the reference numerals 38a and 38b will be used, and when the individual electrical power supply circuits are described without distinguishing therebetween, the reference numeral 38 will be used.

The electrical power supply system 26 may be equipped with a plurality of load modules 40. In the plurality of load modules 40, there may be included a load module 40a, and a load module 40b. When the individual load modules are described while distinguishing therebetween, the reference numerals 40a and 40b will be used, and when the individual load modules are described without distinguishing therebetween, the reference numeral 40 will be used.

The electrical power supply circuit 38a supplies a DC electrical power that is supplied from the electrical power generating device 30 to the load device 40a. The electrical power supply circuit 38b supplies a DC electrical power that is supplied from the electrical power generating device 30 to the load device 40b.

A plurality of load devices 42 may be provided in the load modules 40. The plurality of load devices 42 may include a load device 42aa, a load device 42ab, a load device 42ac, a load device 42ad, a load device 42ba, a load device 42bb, a load device 42bc, and a load device 42bd. When the individual load devices are described while distinguishing therebetween, the reference numerals 42aa to 42ad and 42ba to 42bd will be used, and when the individual load devices are described without distinguishing therebetween, the reference numeral 42 will be used.

When the load device 42aa that is provided in the load module 40a, and the load device 42ba that is provided in the load module 40b are described without distinguishing therebetween, the reference numeral 42a will be used. When the load device 42aa that is provided in the load module 40a, and the load device 42ba that is provided in the load module 40b are described while distinguishing therebetween, the reference numerals 42aa and 42ba will be used.

When the load device 42ab that is provided in the load module 40a, and the load device 42bb that is provided in the load module 40b are described without distinguishing therebetween, the reference numeral 42b will be used. When the load device 42ab that is provided in the load module 40a, and the load device 42bb that is provided in the load module 40b are described while distinguishing therebetween, the reference numerals 42ab and 42bb will be used.

When the load device 42ac that is provided in the load module 40a, and the load device 42bc that is provided in the load module 40b are described without distinguishing therebetween, the reference numeral 42c will be used. When the load device 42ac that is provided in the load module 40a, and the load device 42bc that is provided in the load module 40b are described while distinguishing therebetween, the reference numerals 42ac and 42bc will be used.

The load devices 42a to 42c are driven at a comparatively high voltage. The load device 42a and the load device 42b each include, for example, a drive device 46 and a VTOL electric motor 20. The load device 42c includes the drive device 46 and the cruise electric motor 24. The drive device 46 is an inverter having a non-illustrated switching element. By controlling the switching element, the drive device 46 converts the DC electrical power that is input to the drive device 46 into a three phase AC electrical power and outputs the AC electrical power to the VTOL electric motor 20 or the cruise electric motor 24. A smoothing capacitor 44aa may be provided in the load device 42aa. A smoothing capacitor 44ab may be provided in the load device 42ab. A smoothing capacitor 44ac may be provided in the load device 42ac. A smoothing capacitor 44ba may be provided in the load device 42ba. A smoothing capacitor 44bb may be provided in the load device 42bb. A smoothing capacitor 44bc may be provided in the load device 42bc. When the individual smoothing capacitors are described while distinguishing therebetween, the reference numerals 44aa to 44ac and 44ba to 44bc will be used, and when the individual smoothing capacitors are described without distinguishing therebetween, the reference numeral 44 will be used. The smoothing capacitors 44aa to 44ac and 44ba to 44bc may be provided inside the drive devices 46 that are provided in the load devices 42a to 42c, respectively, although the smoothing capacitors are not necessarily limited to this feature.

The load device 42d is driven at a comparatively low voltage. The rated voltage of the load device 42d is lower than the rated voltage of the load devices 42a to 42c. The load device 42d may be, but is not limited to being, an air conditioner, avionics, a pump, or the like. The rated voltage of the load device 42d, for example, is of several tens of volts, although the rated voltage thereof is not necessarily limited to this value.

Each of the respective load devices 42 may include various elements, such as various sensors such as voltage sensors, electrical current sensors or the like, fuses, relays, breakers, diodes, transistors, resistors, coils, capacitors, and the like.

The electrical power supply system 26 includes a plurality of power storage devices 52. A power storage device 52a and a power storage device 52b may be included in the power storage devices 52. When the individual power storage devices are described while distinguishing therebetween, the reference numerals 52a and 52b will be used, and when the individual power storage devices are described without distinguishing therebetween, the reference numeral 52 will be used. The power storage devices 52 can be connected via a disconnection device 78 to each of the electrical power supply circuits 38. The power storage devices 52 can be connected to the electrical power supply circuits 38 in parallel with the electrical power generating device 30. Each of the power storage devices 52 includes a battery 54. The battery 54, for example, is a lithium ion battery. The rated output voltage of the power storage devices 52 is comparatively high. The rated output voltage of the power storage devices 52, for example, is several hundred volts, although the power storage devices are not necessarily limited to this feature.

Each of the respective power storage devices 52 may include various elements, such as various sensors such as voltage sensors, electrical current sensors or the like, fuses, relays, breakers, diodes, transistors, resistors, coils, capacitors, and the like.

The electrical power supply system 26 includes a plurality of power storage devices 53. A power storage device 53a and a power storage device 53b may be included in the power storage devices 53. When the individual power storage devices are described while distinguishing therebetween, the reference numerals 53a and 53b will be used, and when the individual power storage devices are described without distinguishing therebetween, the reference numeral 53 will be used. The rated output voltage of the power storage devices 53 is lower than the rated output voltage of the power storage devices 52. The rated output voltage of the power storage devices 53, for example, is 24 V, 48 V, or the like, although the rated output voltage is not necessarily limited to this value. The power storage devices 53 are capable of being connected, via later-described voltage conversion devices 47, to the electrical power supply circuits 38. The power storage devices 53 can be connected to the electrical power supply circuits 38 in parallel with the electrical power generating device 30. Each of the power storage devices 53 includes a battery 55. The battery 55, for example, is a lithium ion battery. The power storage devices 53 can supply the electrical power to the load device 42d. More specifically, the power storage device 53a is capable of supplying electrical power to the load device 42ad. The power storage device 53b can supply the electrical power to the load device 42bd.

Each of the respective power storage devices 53 may include various elements, such as various sensors such as voltage sensors, electrical current sensors or the like, fuses, relays, breakers, diodes, transistors, resistors, coils, capacitors, and the like.

The electrical power supply system 26 includes a plurality of voltage conversion devices 47. A voltage conversion device 47a and a voltage conversion device 47b may be included in the plurality of voltage conversion devices 47. When the individual voltage conversion devices are described while distinguishing therebetween, the reference numerals 47a and 47b will be used, and when the individual load devices are described without distinguishing therebetween, the reference numeral 47 will be used. The voltage conversion devices 47 are capable of stepping down the DC electrical power that is supplied from a primary side (a high voltage side) and supplying decreased DC electrical power to a secondary side (a low voltage side). Further, the voltage conversion devices 47 are capable of boosting a DC electrical power that is supplied from the secondary side (the low voltage side) and supplying increased DC electrical power to a primary side (a high voltage side).

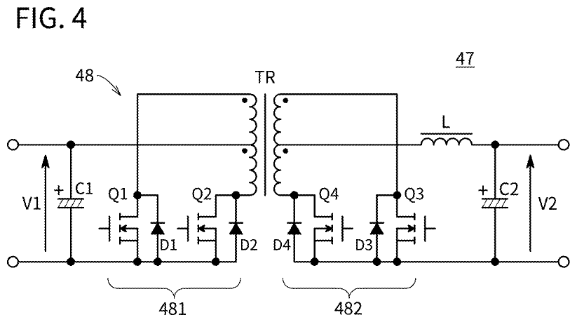

The voltage conversion devices 47 comprise, for example, a bidirectional DC/DC converter 48 with a variable transformation ratio. FIG. 4 is a circuit diagram showing an example of the DC/DC converter. The DC/DC converter 48 is equipped with a non-illustrated electrical current limiting function that limits the output electrical current to less than or equal to a predetermined electrical current limit value. Further, the DC/DC converter 48 is capable of carrying out a constant voltage (Constant Voltage: CV) control in order to maintain a stable output voltage. The DC/DC converter 48, for example, is a DAB (Dual Active Bridge) converter, although the DC/DC converter is not necessarily limited to this feature. The DC/DC converter 48 may be equipped with switching elements Q1 to Q4, an inductor L, rectifying diodes D1 to D4, smoothing capacitors C1 and C2, and an insulating transformer TR. A push-pull circuit 481 including the switching element Q1 and the switching element Q2 is provided on a primary side of the DC/DC converter 48. A push-pull circuit 482 including the switching element Q3 and the switching element Q4 is provided on a secondary side of the DC/DC converter 48. The insulating transformer TR is provided between the push-pull circuit 481 and the push-pull circuit 482. In a state in which the switching element Q3 and the switching element Q4 are set to OFF, in the case that the switching elements Q1 and Q2 are switched at a high frequency, the DC voltage V1 on the primary side is converted into an AC voltage, and the AC voltage is supplied to the secondary side via the insulating transformer TR. The AC voltage that is supplied to the secondary side is smoothed by the smoothing capacitor C2, and a DC voltage V2 is obtained. On the other hand, in a state in which the switching element Q1 and the switching element Q2 are set to OFF, when the switching element Q3 and the switching element Q4 are switched at a high frequency, the DC voltage V2 on the secondary side is converted into an AC voltage, and the AC voltage is supplied to the primary side via the insulating transformer TR. The AC voltage that is supplied to the primary side is smoothed by the smoothing capacitor C1, and a DC voltage V1 is obtained. In the above description, although an example of the insulated DC/DC converter 48 has been described in which the primary side and the secondary side are insulated by the insulating transformer TR, the present invention is not necessarily limited to this feature. A non-insulated DC/DC converter in which the primary side and the secondary side are not insulated may also be provided in the voltage conversion devices 47. The transformation ratio of the voltage conversion devices 47 can be controlled by a control unit 92.

The electrical power supply system 26 comprises a low voltage circuit 49a and a low voltage circuit 49b. The voltage conversion device 47a is positioned between the electrical power supply circuit 38a and the low voltage circuit 49a. The voltage conversion device 47b is positioned between the electrical power supply circuit 38b and the low voltage circuit 49b. The voltage conversion device 47a is capable of stepping down the DC electrical power that is supplied from the electrical power supply circuit 38a. The DC electrical power that is stepped down by the voltage conversion device 47a can be supplied, via the low voltage circuit 49a, to the power storage device 53a. Further, the DC electrical power that is stepped down by the voltage conversion device 47a can be supplied, via the low voltage circuit 49a, to the load device 42ad. The voltage conversion device 47b is capable of stepping down the DC electrical power that is supplied from the electrical power supply circuit 38b. The DC electrical power that is stepped down by the voltage conversion device 47b can be supplied, via the low voltage circuit 49b, to the power storage device 53b. Further, the DC electrical power that is stepped down by the voltage conversion device 47b can be supplied, via the low voltage circuit 49b, to the load device 42bd.

The voltage conversion device 47a is connected to the electrical power supply circuit 38a at a position between a reverse flow prevention device 70a and the load devices 42aa, 42ab, and 42ac. The voltage conversion device 47b is connected to the electrical power supply circuit 38b at a position between a reverse flow prevention device 70b and the load devices 42ba, 42bb, and 42bc. The voltage conversion device 47a is capable of boosting the DC electrical power that is supplied from the power storage device 53a via the low voltage circuit 49a. The DC electrical power that is boosted by the voltage conversion device 47a is supplied to the electrical power supply circuit 38a. The voltage conversion device 47b is capable of boosting the DC electrical power that is supplied from the power storage device 53b via the low voltage circuit 49b. The DC electrical power that is boosted by the voltage conversion device 47b is supplied to the electrical power supply circuit 38b.

The electrical power supply system 26 includes a plurality of disconnection devices 62. The plurality of disconnection devices 62 may include a disconnection device 62a and a disconnection device 62b. When the individual disconnection devices are described while distinguishing therebetween, the reference numerals 62a and 62b will be used, and when the individual disconnection devices are described without distinguishing therebetween, the reference numeral 62 will be used. The disconnection device 62a includes two contactors 64aa and 64ab. The contactor 64aa, which is one of the two contactors 64aa and 64ab, is disposed on a positive electrode wiring, and the contactor 64ab, which is the other of the two contactors 64aa and 64ab, is disposed on a negative electrode wiring. The disconnection device 62b includes two contactors 64ba and 64bb. The contactor 64ba, which is one of the two contactors 64ba and 64bb, is disposed on a positive electrode wiring, and the other contactor 64bb, which is the other of the two contactors 64ba and 64bb, is disposed on a negative electrode wiring. When the contactors are described while distinguishing therebetween, the reference numerals 64aa and 64ab, and 64ba and 64bb will be used, and when the individual contactors are described without distinguishing therebetween, the reference numeral 64 will be used.

The disconnection device 62a is capable of disconnecting the electrical power generating device 30 from the electrical power supply circuit 38a. The disconnection device 62b is capable of disconnecting the electrical power generating device 30 from the electrical power supply circuit 38b.

The electrical power supply system 26 includes a plurality of reverse flow prevention devices 70. The reverse flow prevention device 70a and the reverse flow prevention device 70b may be included in the reverse flow prevention devices 70. When the individual reverse flow prevention devices are described while distinguishing therebetween, the reference numerals 70a and 70b will be used, and when the individual reverse flow prevention devices are described without distinguishing therebetween, the reference numeral 70 will be used. The reverse flow prevention device 70a is disposed in a positive electrode of the electrical power supply circuit 38a. The reverse flow prevention device 70b is disposed in a positive electrode of the electrical power supply circuit 38b. Moreover, each of the reverse flow prevention devices 70 may be disposed in a negative electrode of each of the electrical power supply circuits 38.

The reverse flow prevention device 70a includes a reverse flow prevention element 72a. The reverse flow prevention device 70b includes a reverse flow prevention element 72b. When the individual reverse flow prevention elements are described while distinguishing therebetween, the reference numerals 72a and 72b will be used, and when the individual reverse flow prevention elements are described without distinguishing therebetween, the reference numeral 72 will be used. The reverse flow prevention elements 72, for example, are diodes. The anode of the diode that constitutes the reverse flow prevention element 72a can be connected to the positive electrode of the electrical power generating device 30, for example, via the contactor 64aa that is provided in the positive electrode of the electrical power supply circuit 38a. For example, while being electrically connected to the positive electrode of the load devices 42aa to 42ac and the positive electrode of the voltage conversion device 47a, the cathode of the diode that constitutes the reverse flow prevention element 72a can be electrically connected, via a later-described contactor 80aa that is provided in the disconnection device 78a, to the positive electrode of the power storage device 52a. The reverse flow prevention element 72a prevents reverse flowing of the electrical current in the electrical power supply circuit 38a. More specifically, the reverse flow prevention element 72a permits the electrical power to be supplied from the electrical power generating device 30 to the load devices 42aa to 42ac, however, does not permit the electrical power to be supplied from the load devices 42aa to 42ac to the electrical power generating device 30. The anode of the diode that constitutes the reverse flow prevention element 72b can be connected to the positive electrode of the electrical power generating device 30, for example, via the contactor 64ba that is provided in the positive electrode of the electrical power supply circuit 38b. For example, while being electrically connected to the positive electrode of the load devices 42ba to 42bc and the positive electrode of the voltage conversion device 47b, the cathode of the diode that constitutes the reverse flow prevention element 72b can be electrically connected, via a later-described contactor 80ba that is provided in the disconnection device 78b, to the positive electrode of the power storage device 52b. The reverse flow prevention element 72b prevents reverse flowing of the electrical current in the electrical power supply circuit 38b. More specifically, the reverse flow prevention element 72b permits the electrical power to be supplied from the electrical power generating device 30 to the load devices 42ba to 42bc, however, does not permit the electrical power to be supplied from the load devices 42ba to 42bc to the electrical power generating device 30.

The reverse flow prevention device 70a includes a reverse flow allowing element 74a. The reverse flow prevention device 70b includes a reverse flow allowing element 74b. When the individual reverse flow allowing elements are described while distinguishing therebetween, the reference numerals 74a and 74b will be used, and when the individual reverse flow allowing elements are described without distinguishing therebetween, the reference numeral 74 will be used. The reverse flow allowing elements 74 are disposed in parallel with the reverse flow prevention elements 72. The reverse flow allowing elements 74 may be constituted, for example, by an insulated gate bipolar transistor (Insulated Gate Bipolar Transistor, hereinafter referred to as an IGBT), although the reverse flow allowing elements are not necessarily limited to this feature. The reverse flow allowing elements 74 may be configured by a contactor, a relay, or the like. In the case that the reverse flow allowing elements 74 are in an OFF state, the reverse flow prevention elements 72 prevent the reverse flowing of the electrical current in each of the electrical power supply circuits 38a and 38b. More specifically, by setting the reverse flow allowing element 74a in an OFF state, the reverse flow prevention device 70a is set to a state in which a reverse flow of the electrical current in the electrical power supply circuit 38a is not permitted. Further, by setting the reverse flow allowing element 74b in an OFF state, the reverse flow prevention device 70b is set to a state in which a reverse flow of the electrical current in the electrical power supply circuit 38b is not permitted. In the case that the reverse flow allowing elements 74 are in an ON state, since the electrical current flows through the reverse flow allowing elements 74 in a bypassing manner to the reverse flow prevention elements 72, reverse flowing of the electrical current in the electrical power supply circuit 38 is allowed. The reverse flow allowing element 74a allows reverse flowing of the electrical current in the electrical power supply circuit 38a. More specifically, by setting the reverse flow allowing element 74a in an ON state, the reverse flow prevention device 70a is set to a state in which a reverse flow of the electrical current in the electrical power supply circuit 38a is allowed. The reverse flow allowing element 74b allows reverse flowing of the electrical current in the electrical power supply circuit 38b. More specifically, by setting the reverse flow allowing element 74b in an ON state, the reverse flow prevention device 70b is set to a state in which a reverse flow of the electrical current in the electrical power supply circuit 38b is allowed.

The electrical power supply system 26 includes a plurality of disconnection devices 78. The plurality of disconnection devices 78 may include a disconnection device 78a and a disconnection device 78b. When the individual disconnection devices are described while distinguishing therebetween, the reference numerals 78a and 78b will be used, and when the individual disconnection devices are described without distinguishing therebetween, the reference numeral 78 will be used.

The disconnection device 78a includes two contactors 80aa and 80ab. The contactor 80aa, which is one from among the two contactors 80aa and 80ab, is disposed on a positive electrode wiring. The contactor 80ab, which is the other from among the two contactors 80aa and 80ab, is disposed on a negative electrode wiring. Moreover, it should be noted that only one of the contactor 80aa and the contactor 80ab may be provided in the disconnection device 78a. The disconnection device 78b includes two contactors 80ba and 80bb. The contactor 80ba, which is one from among the two contactors 80ba and 80bb, is disposed on a positive electrode wiring. The contactor 80bb, which is the other from among the two contactors 80ba and 80bb, is disposed on a negative electrode wiring. Moreover, it should be noted that only one from among the contactor 80ba and the contactor 80bb may be provided in the disconnection device 78b. When the contactors are described while distinguishing therebetween, the reference numerals 80aa and 80ab, and 80ba and 80bb will be used, and when the individual contactors are described without distinguishing therebetween, the reference numeral 80 will be used.

The disconnection device 78a is capable of disconnecting the power storage device 52a from the electrical power supply circuit 38a. The disconnection device 78b is capable of disconnecting the power storage device 52b from the electrical power supply circuit 38b.

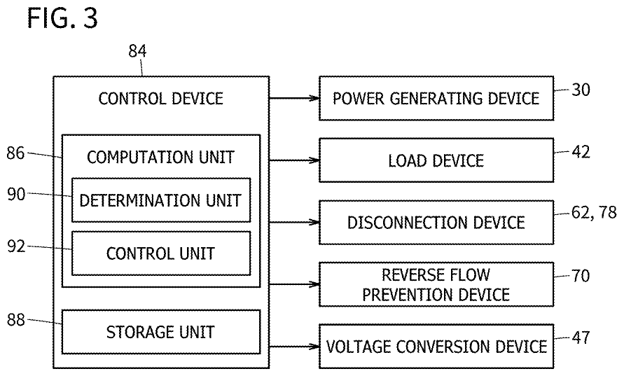

The electrical power supply system 26 is equipped with a control device 84. FIG. 3 is a block diagram showing a configuration of the control device according to the present embodiment.

As shown in FIG. 3, the control device 84 includes a computation unit 86 and a storage unit 88. The computation unit 86 includes a processor such as a CPU (Central Processing Unit) or a GPU (Graphics Processing Unit) or the like. The computation unit 86 includes a determination unit 90 and the control unit 92. The determination unit 90 and the control unit 92 are realized by the computation unit 86 executing a program that is stored in the storage unit 88. At least a portion of the determination unit 90 and the control unit 92 may be realized by an integrated circuit such as an ASIC (Application Specific Integrated Circuit) or an FPGA (Field Programmable Gate Array) or the like. At least one of the determination unit 90 and the control unit 92 may be realized by an electronic circuit including a discrete device.

The storage unit 88 is a computer readable non-transitory tangible storage medium. The storage unit 88 is constituted by a non-illustrated volatile memory, and a non-illustrated non-volatile memory. The volatile memory, for example, is a RAM (Random Access Memory) or the like. The non-volatile memory, for example, is a ROM (Read Only Memory), a flash memory, or the like. Data and the like are stored, for example, in the volatile memory. A program, a table, a map and the like are stored, for example, in the non-volatile memory. At least a portion of the storage unit 88 may be provided in the aforementioned processor, the integrated circuit, or the like. At least a portion of the storage unit 88 may be installed in a device that is connected by a network to the moving object 10.

As noted previously, the control unit 92 may be provided in the control device 84. The control unit 92 is responsible for the overall control of the control device 84. The control unit 92 is capable of controlling each of the electrical power generating device 30, the load device 42, the disconnection devices 62 and 78, the reverse flow prevention device 70, and the voltage conversion devices 47. Moreover, a distributed control may be carried out by the control unit 92 that is provided in each of a plurality of control devices 84.

The control unit 92, by supplying the electrical power from the power storage device 53a to the electrical power supply circuit 38a via the voltage conversion device 47a, is capable of carrying out a charge supply control to supply an electrical charge to the load devices 42aa to 42ac. More specifically, the control unit 92 is capable of executing a charge supply control. In the case that a reverse flow of the electrical current in the electrical power supply circuit 38a is allowed by the reverse flow allowing element 74a, by the charge supply control, the electrical charge can also be supplied to the electrical power generating device 30. The control unit 92 executes the charge supply control in a state in which the power storage device 52a is disconnected from the electrical power supply circuit 38a. By the electrical power supply control being carried out, pre-charging with respect to the smoothing capacitors 44aa, 44ab, and 44ac that are provided in each of the load devices 42aa to 42ac can be carried out. In the case that a reverse flow of the electrical current is allowed by the reverse flow allowing element 74a, pre-charging with respect to the smoothing capacitor 44d that is provided in the electrical power generating device 30 can be carried out. Moreover, the supply of the electrical charge that is executed in the charge supply control is not limited to pre-charging of the smoothing capacitors 44 that are provided in the load devices 42 and the like. The supply of the electrical power (the charge) in order to cause at least a portion of the load devices 42 and the like to be driven may be carried out in the charge supply control.

The control unit 92, by supplying the electrical power from the power storage device 53b to the electrical power supply circuit 38b via the voltage conversion device 47b, is capable of carrying out a charge supply control to supply an electrical charge to the load devices 42ba to 42bc. In the case that a reverse flow of the electrical current in the electrical power supply circuit 38b is allowed by the reverse flow allowing element 74b, by the charge supply control, the electrical charge can also be supplied to the electrical power generating device 30. The control unit 92 executes the charge supply control in a state in which the power storage device 52b is disconnected from the electrical power supply circuit 38b. By the electrical power supply control being carried out, pre-charging with respect to the smoothing capacitors 44ba, 44bb, and 44bc that are provided in each of the load devices 42ba to 42bc can be carried out. In the case that a reverse flow of the electrical current is allowed by the reverse flow allowing element 74b, pre-charging with respect to the smoothing capacitor 44d that is provided in the electrical power generating device 30 can be carried out.

In the case that the output voltage of the power storage device 52a is lower than the output voltage of the power storage device 52b, while permitting the reverse flowing of the electrical current in the electrical power supply circuit 38a by the reverse flow allowing element 74a, the control unit 92 executes the charge supply control in a state in which the reverse flowing of the electrical current in the electrical power supply circuit 38b is blocked by the reverse flow prevention element 72b.

In the case that the output voltage of the power storage device 52b is lower than the output voltage of the power storage device 52a, while permitting the reverse flowing of the electrical current in the electrical power supply circuit 38b by the reverse flow allowing element 74b, the control unit 92 executes the charge supply control in a state in which the reverse flowing of the electrical current in the electrical power supply circuit 38a is blocked by the reverse flow prevention element 72a.

As noted previously, the determination unit 90 may be provided in the control device 84. The determination unit 90 is capable of determining whether or not the difference between the voltage of the smoothing capacitors 44 and the output voltage of the power storage devices 52 is less than or equal to the predetermined difference threshold value. More specifically, the determination unit 90 is capable of determining whether or not the difference between the voltage of the smoothing capacitors 44aa to 44ac and the output voltage of the power storage device 52a is less than or equal to the predetermined difference threshold value. The voltage of the smoothing capacitors 44aa to 44ac can be grasped based on the measurement result obtained by a non-illustrated voltage sensor that serves to measure the voltage at the cathode of the reverse flow prevention element 72a. In the case that the reverse flowing of the electrical current in the electrical power supply circuit 38a is allowed by the reverse flow allowing element 74a, the determination unit 90 is capable of determining whether or not the difference between the voltage of the smoothing capacitors 44aa to 44ac and 44d and the output voltage of the power storage device 52a is less than or equal to the predetermined difference threshold value. Further, the determination unit 90 is capable of determining whether or not the difference between the voltage of the smoothing capacitors 44ba to 44bc and the output voltage of the power storage device 52b is less than or equal to the predetermined difference threshold value. The voltage of the smoothing capacitors 44ba to 44bc can be grasped based on the measurement result obtained by a non-illustrated voltage sensor that serves to measure the voltage at the cathode of the reverse flow prevention element 72b. In the case that the reverse flowing of the electrical current in the electrical power supply circuit 38b is allowed by the reverse flow allowing element 74b, the determination unit 90 is capable of determining whether or not the difference between the voltage of the smoothing capacitors 44ba to 44bc and 44d and the output voltage of the power storage device 52b is less than or equal to the predetermined difference threshold value.

In the case that the determination unit 90 has determined that the difference between the voltage of the smoothing capacitors 44aa to 44ac and the output voltage of the power storage device 52a is less than or equal to the difference threshold value, the control unit 92 connects the power storage device 52a to the electrical power supply circuit 38a. Specifically, the control unit 92, by placing all of the contactors 80 that are provided in the disconnection device 78a in an ON state, serves to connect the power storage device 52a to the electrical power supply circuit 38a. In the case that the determination unit 90 has determined that the difference between the voltage of the smoothing capacitors 44ba to 44bc and the output voltage of the power storage device 52b is less than or equal to the difference threshold value, the control unit 92 connects the power storage device 52b to the electrical power supply circuit 38b. Specifically, the control unit 92, by placing all of the contactors 80 that are provided in the disconnection device 78b in an ON state, serves to connect the power storage device 52b to the electrical power supply circuit 38b.

After the power storage devices 52 have been connected to the electrical power supply circuits 38, the control unit 92, using the electrical power that is supplied from the power storage devices 52, starts the engine 32 that is connected to the generator 34 that is provided in the electrical power generating device 30. In the case that it is attempted to start the engine 32 using the electrical power that is supplied from the power storage devices 52 whose output voltage is high, there is a concern that an inrush current may flow from the power storage devices 52 whose output voltage is high to the power storage devices 52 whose output voltage is low. Therefore, the engine 32 is started using the electrical power that is supplied from the power storage devices 52 whose output voltage is low. In the case that the output voltage of the power storage device 52a is lower than the output voltage of the power storage device 52b, the engine 32 is started using the electrical power that is supplied from the power storage device 52a. In the case that the output voltage of the power storage device 52b is lower than the output voltage of the power storage device 52a, the engine 32 is started using the electrical power that is supplied from the power storage device 52b.

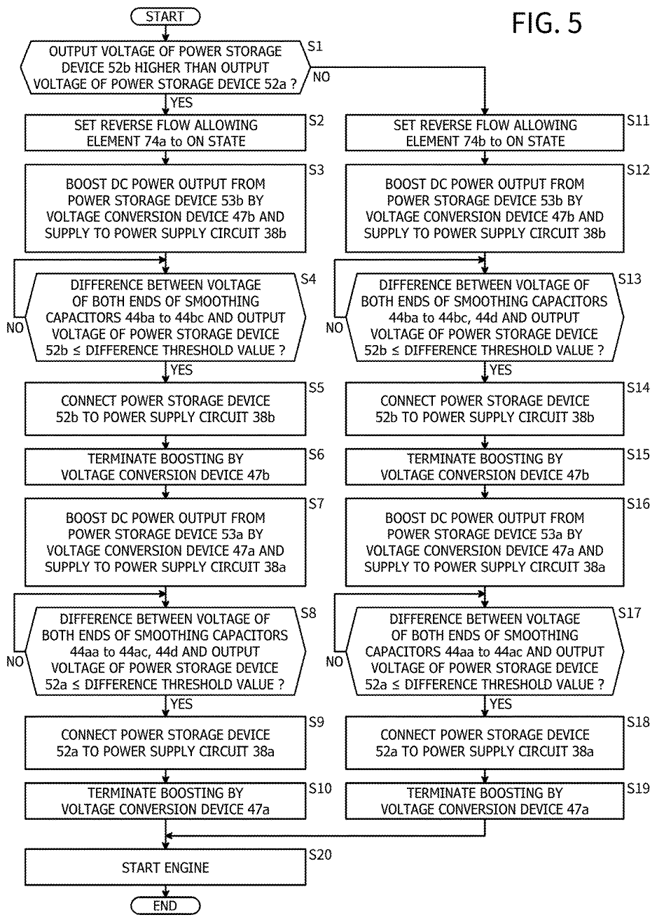

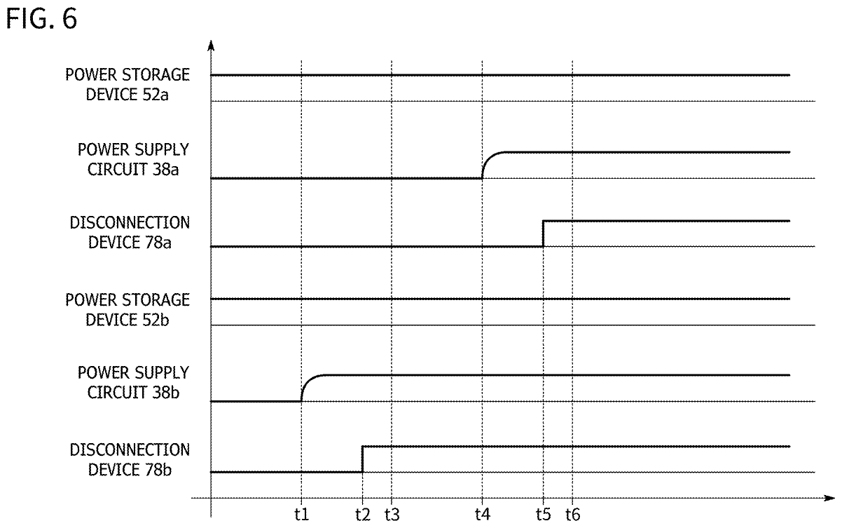

A description will be given with reference to FIG. 5 and FIG. 6 concerning an example of operations of the electrical power supply system according to the present embodiment. FIG. 5 is a flowchart showing an example of operations of the electrical power supply system according to the present embodiment. FIG. 6 is a time chart showing an example of operations of the electrical power supply system according to the present embodiment. Operations in relation to pre-charging of the smoothing capacitors 44 and starting the engine 32 are shown in FIG. 5 and FIG. 6. When pre-charging is carried out, all of the contactors 64 that are provided in the disconnection device 62a are set to an ON state in advance, and further, all of the contactors 80 that are provided in the disconnection devices 78 are set to an OFF state in advance.

In step S1, the control unit 92 compares the output voltage of the power storage device 52a and the output voltage of the power storage device 52b. The output voltage of the power storage device 52a can be measured by a non-illustrated voltage sensor that is electrically connected to an output terminal of the power storage device 52a. The output voltage of the power storage device 52b can be measured by a non-illustrated voltage sensor that is electrically connected to an output terminal of the power storage device 52b. In the case that the output voltage of the power storage device 52b is higher than the output voltage of the power storage device 52a (YES in step S1), the process transitions to step S2. In the case that the output voltage of the power storage device 52b is less than or equal to the output voltage of the power storage device 52a (NO in step S1), the process transitions to step S11.

In step S2, the control unit 92 sets the reverse flow allowing element 74a that is provided in the reverse flow prevention device 70a to the ON state. A reverse flow of the electrical current in the electrical power supply circuit 38a is allowed by the reverse flow allowing element 74a. Thereafter, the process transitions to step S3.

In step S3, the control unit 92 boosts the DC electrical power that is output from the power storage device 53b by means of the voltage conversion device 47b, and supplies the DC electrical power that was boosted to the electrical power supply circuit 38b. The timing t1 shown in FIG. 6 is a timing at which the boosting by the voltage conversion device 47b is started. The target output voltage of the voltage conversion device 47b is set to be equal to the output voltage of the power storage device 52b. Apart from the fact that the electrical current limiting function is provided in the voltage conversion device 47b, since the smoothing capacitors 44ba to 44bc have a certain amount of capacitance, the voltage of the smoothing capacitors 44ba to 44bc gradually rise. Due to the electrical current limitation, the smoothing capacitors 44ba to 44bc are charged with a constant electrical current. Since the reverse flow allowing element 74b that is provided in the reverse flow prevention device 70b is placed in the OFF state, supplying of an electrical charge to the smoothing capacitors 44d and 44aa to 44ac is not carried out. Thereafter, the process transitions to step S4.

In step S4, the determination unit 90 determines whether or not the difference between the voltage of the smoothing capacitors 44ba to 44bc and the output voltage of the power storage device 52b is less than or equal to the predetermined difference threshold value. The voltage of the smoothing capacitors 44ba to 44bc can be grasped based on the measurement result obtained by a non-illustrated voltage sensor that serves to measure the voltage at the cathode of the reverse flow prevention element 72b. In the case that the difference between the voltage of the smoothing capacitors 44ba to 44bc and the output voltage of the power storage device 52b is greater than the predetermined difference threshold value (NO in step S4), step S4 is repeated. In the case that the difference between the voltage of the smoothing capacitors 44ba to 44bc and the output voltage of the power storage device 52b is less than or equal to the predetermined difference threshold value (YES in step S4), the process transitions to step S5.

In step S5, the control unit 92 connects the power storage device 52b to the electrical power supply circuit 38b. Specifically, the control unit 92, by placing all of the contactors 80 that are provided in the disconnection device 78b in an ON state, serves to connect the power storage device 52b to the electrical power supply circuit 38b. The timing t2 shown in FIG. 6 is a timing at which all of the contactors 80 that are provided in the disconnection device 78b are placed in an ON state. Thereafter, the process transitions to step S6.

In step S6, the control unit 92 brings the voltage boosting by the voltage conversion device 47b to an end. The timing t3 shown in FIG. 6 is a timing at which the boosting by the voltage conversion device 47b comes to an end. Thereafter, the process transitions to step S7.

In step S7, the control unit 92 boosts the DC electrical power that is output from the power storage device 53a by means of the voltage conversion device 47a, and supplies the DC electrical power that was boosted to the electrical power supply circuit 38a. The timing t4 shown in FIG. 6 is a timing at which the boosting by the voltage conversion device 47a is started. The target output voltage of the voltage conversion device 47a is set to be equal to the output voltage of the power storage device 52a. Since the reverse flow allowing element 74a that is provided in the reverse flow prevention device 70a is in the ON state, an electrical charge is supplied not only to the smoothing capacitors 44aa to 44ac but also to the smoothing capacitor 44d. Apart from the fact that the electrical current limiting function is provided in the voltage conversion device 47a, since the smoothing capacitors 44aa to 44ac and 44d have a certain amount of capacitance, the voltage of the smoothing capacitors 44aa to 44ac and 44d gradually rise. Due to the electrical current limitation, the smoothing capacitors 44aa to 44ac and 44d are charged with a constant electrical current. Thereafter, the process transitions to step S8.

In step S8, the determination unit 90 determines whether or not the difference between the voltages V1 to V3 of the smoothing capacitors 44aa to 44ac and 44d and the output voltage of the power storage device 52a is less than or equal to a difference threshold value. The voltage of the smoothing capacitors 44aa to 44ac and 44d can be grasped based on the measurement result obtained by a non-illustrated voltage sensor that serves to measure the voltage at the cathode of the reverse flow prevention element 72a. In the case that the difference between the voltage of the smoothing capacitors 44aa to 44ac and 44d and the output voltage of the power storage device 52a is greater than the predetermined difference threshold value (NO in step S8), step S8 is repeated. In the case that the difference between the voltage of the smoothing capacitors 44aa to 44ac and 44d and the output voltage of the power storage device 52a is less than or equal to the predetermined difference threshold value (YES in step S8), the process transitions to step S9.

In step S9, the control unit 92 connects the power storage device 52a to the electrical power supply circuit 38a. Specifically, the control unit 92, by placing all of the contactors 80 that are provided in the disconnection device 78a in an ON state, serves to connect the power storage device 52a to the electrical power supply circuit 38a. The timing t5 shown in FIG. 6 is a timing at which all of the contactors 80 that are provided in the disconnection device 78a are placed in an ON state. Thereafter, the process transitions to step S10.

In step S10, the control unit 92 brings the voltage boosting by the voltage conversion device 47a to an end. The timing t6 shown in FIG. 6 is a timing at which the boosting by the voltage conversion device 47a comes to an end. Thereafter, the process transitions to step S20.

As noted previously, in the case that the output voltage of the power storage device 52b is less than or equal to the output voltage of the power storage device 52a (NO in step S1), the process transitions to step S11. In step S11, the control unit 92 places the reverse flow allowing element 74b in an ON state. A reverse flow of the electrical current in the electrical power supply circuit 38b is allowed by the reverse flow allowing element 74b. Thereafter, the process transitions to step S12.

In step S12, the control unit 92 boosts the DC electrical power that is output from the power storage device 53b by means of the voltage conversion device 47b, and supplies the DC electrical power that was boosted to the electrical power supply circuit 38b. The target output voltage of the voltage conversion device 47b is set to be equal to the output voltage of the power storage device 52b. Since the reverse flow allowing element 74b that is provided in the reverse flow prevention device 70b is in the ON state, an electrical charge is supplied not only to the smoothing capacitors 44ba to 44bc but also to the smoothing capacitor 44d. Apart from the fact that the electrical current limiting function is provided in the voltage conversion device 47b, since the smoothing capacitors 44ba to 44bc and 44d have a certain amount of capacitance, the voltage of the smoothing capacitors 44ba to 44bc and 44d gradually rises. Due to the electrical current limitation, the smoothing capacitors 44ba to 44bc and 44d are charged with a constant electrical current. Thereafter, the process transitions to step S13.

In step S13, the determination unit 90 determines whether or not the difference between the voltage of the smoothing capacitors 44ba to 44bc and 44d and the output voltage of the power storage device 52b is less than or equal to the predetermined difference threshold value. In the case that the difference between the voltage of the smoothing capacitors 44ba to 44bc and 44d and the output voltage of the power storage device 52b is greater than the predetermined difference threshold value (NO in step S13), step S13 is repeated. In the case that the difference between the voltage of the smoothing capacitors 44ba to 44bc and 44d and the output voltage of the power storage device 52b is less than or equal to the predetermined difference threshold value (YES in step S13), the process transitions to step S14.

In step S14, the control unit 92 connects the power storage device 52b to the electrical power supply circuit 38b. Thereafter, the process transitions to step S15.

In step S15, the control unit 92 brings the voltage boosting by the voltage conversion device 47b to an end. Thereafter, the process transitions to step S16.

In step S16, the control unit 92 boosts the DC electrical power that is output from the power storage device 53a by means of the voltage conversion device 47a, and supplies the DC electrical power that was boosted to the electrical power supply circuit 38a. The target output voltage of the voltage conversion device 47a is set to be equal to the output voltage of the power storage device 52a. Apart from the fact that the electrical current limiting function is provided in the voltage conversion device 47a, since the smoothing capacitors 44aa to 44ac have a certain amount of capacitance, the voltage of the smoothing capacitors 44aa to 44ac gradually rise. Due to the electrical current limitation, the smoothing capacitors 44aa to 44ac are charged with a constant electrical current. Thereafter, the process transitions to step S17.

In step S17, the determination unit 90 determines whether or not the difference between the voltage of the smoothing capacitors 44aa to 44ac and the output voltage of the power storage device 52a is less than or equal to the difference threshold value. The voltage of the smoothing capacitors 44aa to 44ac can be grasped based on the measurement result obtained by a non-illustrated voltage sensor that serves to measure the voltage at the cathode of the reverse flow prevention element 72a. In the case that the difference between the voltage of the smoothing capacitors 44aa to 44ac and the output voltage of the power storage device 52a is greater than the predetermined difference threshold value (NO in step S17), step S17 is repeated. In the case that the difference between the voltage of the smoothing capacitors 44aa to 44ac and the output voltage of the power storage device 52a is less than or equal to the predetermined difference threshold value (YES in step S17), the process transitions to step S18.

In step S18, the control unit 92 connects the power storage device 52a to the electrical power supply circuit 38a. Thereafter, the process transitions to step S19.

In step S19, the control unit 92 brings the voltage boosting by the voltage conversion device 47a to an end. Thereafter, the process transitions to step S20.

In step S20, the control unit 92, using the electrical power that is supplied from the power storage devices 52, starts the engine 32 that is connected to the generator 34 that is provided in the electrical power generating device 30. In the case that the output voltage of the power storage device 52a is lower than the output voltage of the power storage device 52b, the engine 32 is started using the electrical power that is supplied from the power storage device 52a. In the case that the output voltage of the power storage device 52b is lower than the output voltage of the power storage device 52a, the engine 32 is started using the electrical power that is supplied from the power storage device 52b. In this manner, the process shown in FIG. 5 comes to an end.

Moreover, it should be noted that steps S3 to S6 and steps S7 to S10 may be interchanged. More specifically, steps S7 to S10 may be executed after step 2, steps S3 to S6 may be executed after step S10, and step S20 may be executed after step S6.

Moreover, it should be noted that steps S12 to S15 and steps S16 to S19 may be interchanged. More specifically, steps S16 to S19 may be executed after step S11, steps S12 to S15 may be executed after step S19, and step S20 may be executed after step S15.

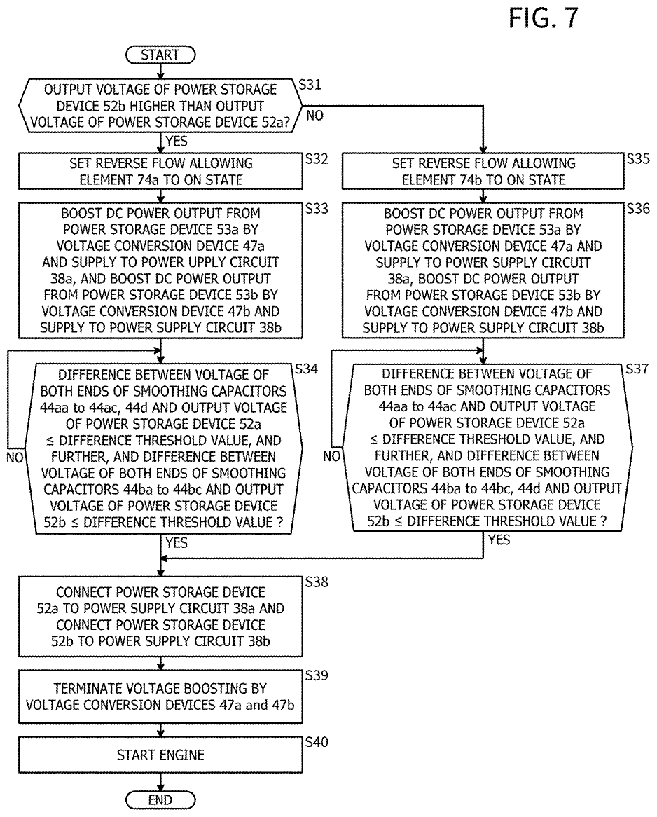

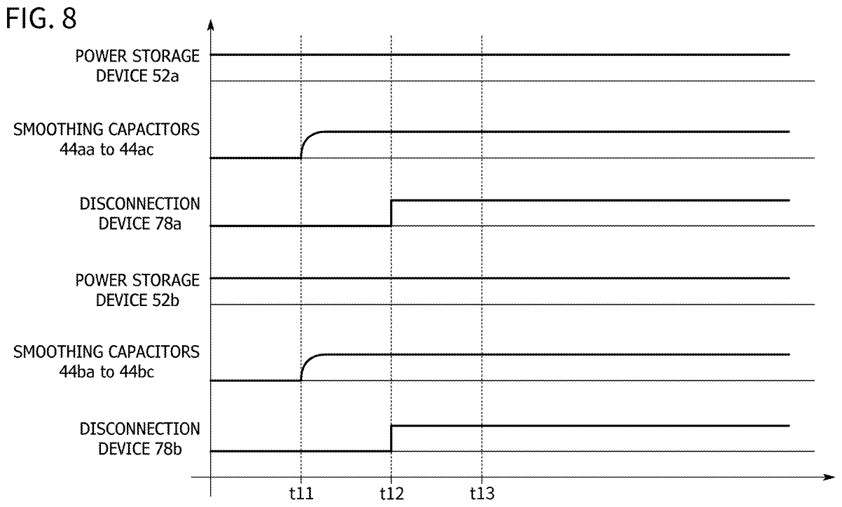

A description will be given with reference to FIG. 7 and FIG. 8 concerning another example of operations of the electrical power supply system according to the present embodiment. FIG. 7 is a flowchart showing another example of operations of the electrical power supply system according to the present embodiment. FIG. 8 is a time chart showing another example of operations of the electrical power supply system according to the present embodiment. Operations in relation to pre-charging the smoothing capacitors 44 and starting the engine 32 are shown in FIG. 7 and FIG. 8. When pre-charging is carried out, all of the contactors 64 that are provided in the disconnection device 62a are set to an ON state in advance, and further, all of the contactors 80 that are provided in the disconnection devices 78 are set to an OFF state in advance.

In step S31, similarly to step S1, the control unit 92 compares the output voltage of the power storage device 52a and the output voltage of the power storage device 52b. In the case that the output voltage of the power storage device 52b is higher than the output voltage of the power storage device 52a (YES in step S31), the process transitions to step S32. In the case that the output voltage of the power storage device 52b is less than or equal to the output voltage of the power storage device 52a (NO in step S31), the process transitions to step S35.

In step S32, the control unit 92, similarly to step S2, sets the reverse flow allowing element 74a that is provided in the reverse flow prevention device 70a to the ON state. Thereafter, the process transitions to step S33.

In step S33, the control unit 92 boosts the DC electrical power that is output from the power storage device 53a by means of the voltage conversion device 47a, and supplies the DC electrical power that was boosted to the electrical power supply circuit 38a. Further, the control unit 92 boosts the DC electrical power that is output from the power storage device 53b by means of the voltage conversion device 47b, and supplies the DC electrical power that was boosted to the electrical power supply circuit 38b. The timing t11 shown in FIG. 8 is a timing at which the boosting by the voltage conversion devices 47a and 47b is started. The target output voltage of the voltage conversion device 47a is set to be equal to the output voltage of the power storage device 52a. Since the reverse flow allowing element 74a that is provided in the reverse flow prevention device 70a is in the ON state, an electrical charge is supplied not only to the smoothing capacitors 44aa to 44ac but also to the smoothing capacitor 44d. Apart from the fact that the electrical current limiting function is provided in the voltage conversion device 47a, since the smoothing capacitors 44aa to 44ac and 44d have a certain amount of capacitance, the voltage of the smoothing capacitors 44aa to 44ac and 44d gradually rise. Due to the electrical current limitation, the smoothing capacitors 44aa to 44ac and 44d are charged with a constant electrical current. The target output voltage of the voltage conversion device 47b is set to be equal to the output voltage of the power storage device 52b. Apart from the fact that the electrical current limiting function is provided in the voltage conversion device 47b, since the smoothing capacitors 44ba to 44bc have a certain amount of capacitance, the voltage of the smoothing capacitors 44ba to 44bc gradually rise. Due to the electrical current limitation, the smoothing capacitors 44ba to 44bc are charged with a constant electrical current. Since the reverse flow allowing element 74b that is provided in the reverse flow prevention device 70b is placed in the OFF state, supplying of an electrical charge from the voltage conversion device 47b to the smoothing capacitors 44d and 44aa to 44ac is not carried out. Thereafter, the process transitions to step S34.

In step S34, the determination unit 90 determines whether or not the difference between the voltage of the smoothing capacitors 44aa to 44ac and 44d and the output voltage of the power storage device 52a is less than or equal to the difference threshold value. In the case that the difference between the voltage of the smoothing capacitors 44aa to 44ac and 44d and the output voltage of the power storage device 52a is greater than the predetermined difference threshold value (NO in step S34), step S34 is repeated. Further, the determination unit 90 determines whether or not the difference between the voltage of the smoothing capacitors 44ba to 44bc and the output voltage of the power storage device 52b is less than or equal to the predetermined difference threshold value. In the case that the difference between the voltage of the smoothing capacitors 44ba to 44bc and the output voltage of the power storage device 52b is greater than the predetermined difference threshold value (NO in step S34), step S34 is repeated. In the case that the difference between the voltage of the smoothing capacitors 44aa to 44ac, 44d and the output voltage of the power storage device 52a is less than or equal to the predetermined difference threshold value, and further, the difference between the voltage of the smoothing capacitors 44ba to 44bc and the output voltage of the power storage device 52b is less than or equal to the predetermined difference threshold value (YES in step S34), the process transitions to step S38.

As noted previously, in the case that the output voltage of the power storage device 52b is less than or equal to the output voltage of the power storage device 52a (NO in step S31), the process transitions to step S35. In step S35 the control unit 92 places the reverse flow allowing element 74b in an ON state. Thereafter, the process transitions to step S36.

In step S36, the control unit 92 boosts the DC electrical power that is output from the power storage device 53a by means of the voltage conversion device 47a, and supplies the DC electrical power that was boosted to the electrical power supply circuit 38a. Further, the control unit 92 boosts the DC electrical power that is output from the power storage device 53b by means of the voltage conversion device 47b, and supplies the DC electrical power that was boosted to the electrical power supply circuit 38b. The target output voltage of the voltage conversion device 47a is set to be equal to the output voltage of the power storage device 52a. Apart from the fact that the electrical current limiting function is provided in the voltage conversion device 47a, since the smoothing capacitors 44aa to 44ac have a certain amount of capacitance, the voltage of the smoothing capacitors 44aa to 44ac gradually rise. Due to the electrical current limitation, the smoothing capacitors 44aa to 44ac are charged with a constant electrical current. Since the reverse flow allowing element 74a that is provided in the reverse flow prevention device 70a is placed in the OFF state, supplying of an electrical charge from the voltage conversion device 47a to the smoothing capacitors 44d and 44ba to 44bc is not carried out. The target output voltage of the voltage conversion device 47b is set to be equal to the output voltage of the power storage device 52b. Since the reverse flow allowing element 74b that is provided in the reverse flow prevention device 70b is in the ON state, an electrical charge is supplied not only to the smoothing capacitors 44ba to 44bc but also to the smoothing capacitor 44d. Apart from the fact that the electrical current limiting function is provided in the voltage conversion device 47b, since the smoothing capacitors 44ba to 44bc and 44d have a certain amount of capacitance, the voltage of the smoothing capacitors 44ba to 44bc and 44d gradually rises. Due to the electrical current limitation, the smoothing capacitors 44ba to 44bc and 44d are charged with a constant electrical current. Thereafter, the process transitions to step S37.

In step S37, the determination unit 90 determines whether or not the difference between the voltage of the smoothing capacitors 44aa to 44ac and the output voltage of the power storage device 52a is less than or equal to the difference threshold value. In the case that the difference between the voltage of the smoothing capacitors 44aa to 44ac and the output voltage of the power storage device 52a is greater than the predetermined difference threshold value (NO in step S37), step S37 is repeated. Further, the determination unit 90 determines whether or not the difference between the voltage of the smoothing capacitors 44ba to 44bc and 44d and the output voltage of the power storage device 52b is less than or equal to the predetermined difference threshold value. In the case that the difference between the voltage of the smoothing capacitors 44ba to 44bc and 44d and the output voltage of the power storage device 52b is greater than the predetermined difference threshold value (NO in step S37), step S37 is repeated. In the case that the difference between the voltage of the smoothing capacitors 44aa to 44ac and the output voltage of the power storage device 52a is less than or equal to the predetermined difference threshold value, and further, the difference between the voltage of the smoothing capacitors 44ba to 44bc and 44d and the output voltage of the power storage device 52b is less than or equal to the predetermined difference threshold value (YES in step S37), the process transitions to step S38.

In step S38, the control unit 92 connects the power storage device 52a to the electrical power supply circuit 38a. Further, the control unit 92 connects the power storage device 52b to the electrical power supply circuit 38b. The timing t12 shown in FIG. 8 is a timing at which all of the contactors 80 that are provided in the disconnection devices 78a and 78b are placed in an ON state. Thereafter, the process transitions to step S39.

In step S39, the control unit 92 brings the voltage boosting by the voltage conversion devices 47a and 47b to an end. The timing t13 shown in FIG. 8 is a timing at which the boosting by the voltage conversion devices 47a and 47b comes to an end. Thereafter, the process transitions to step S40.

In step S40, the control unit 92, using the electrical power that is supplied from the power storage devices 52, starts the engine 32 that is connected to the generator 34 that is provided in the electrical power generating device 30. In the case that the output voltage of the power storage device 52a is lower than the output voltage of the power storage device 52b, the engine 32 is started using the electrical power that is supplied from the power storage device 52a. In the case that the output voltage of the power storage device 52b is lower than the output voltage of the power storage device 52a, the engine 32 is started using the electrical power that is supplied from the power storage device 52b. In this manner, the process shown in FIG. 7 comes to an end.

In this manner, according to the present embodiment, pre-charging is performed using the voltage conversion devices 47. Since the current limiting function is provided in the voltage conversion devices 47, an inrush current does not flow into the smoothing capacitors 44. According to the present embodiment, a pre-charging circuit including a pre-charging resistor or the like, which has a comparatively large mass, is not required, and therefore the weight of the electrical power supply system 26 can be reduced. The reduction in weight of the electrical power supply system 26 can contribute to an increase in the cruising distance of the moving object 10. In this manner, according to the present embodiment, a satisfactory electrical power supply system 26 can be provided.

### Exemplary Modification

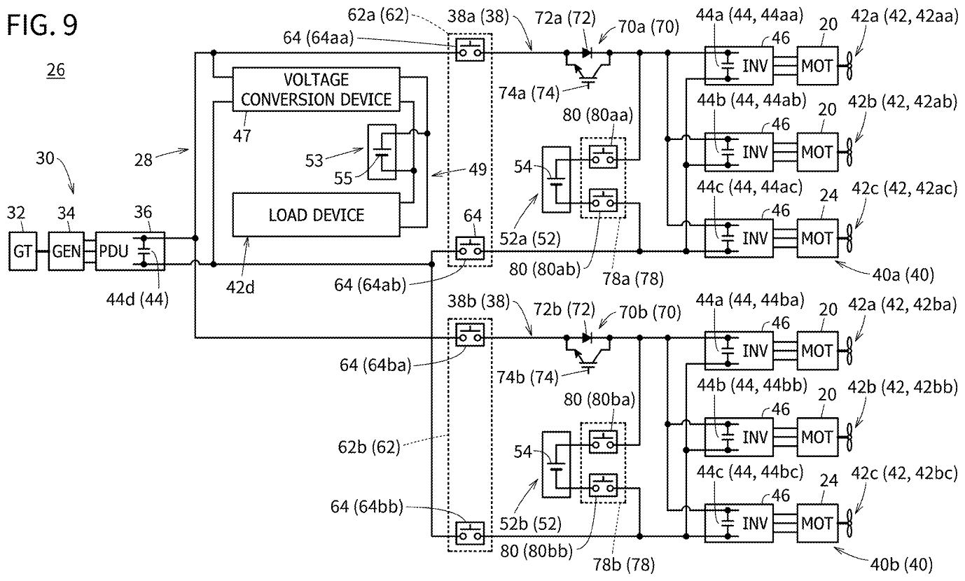

A description will be given with reference to the drawings concerning an electrical power supply system according to an exemplary modification of the present embodiment. FIG. 9 is a schematic diagram showing a configuration of the electrical power supply system according to the exemplary modification of the present embodiment.

According to the present exemplary modification, as shown in FIG. 9, the voltage conversion devices 47 are connected to the electrical power supply circuit 38 at a position between the electrical power generating device 30 and the disconnection devices 62. According to the present exemplary modification, since the DC electrical power that is boosted by the voltage conversion devices 47 is supplied to the electrical power supply circuit 38 at a position between the electrical power generating device 30 and the disconnection devices 62, there is no need to provide the voltage conversion devices 47 with respect to each of the electrical power supply circuit 38a and the electrical power supply circuit 38b.

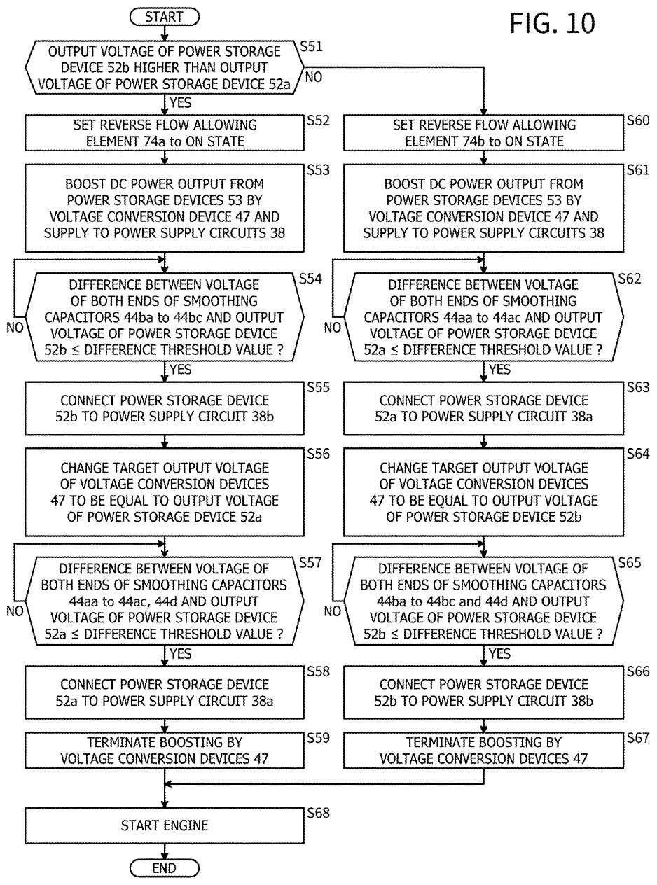

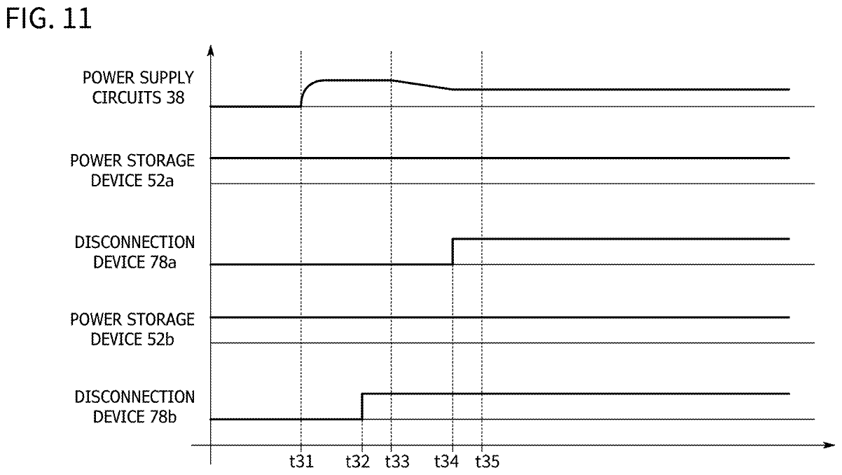

A description will be given with reference to FIG. 10 and FIG. 11 concerning an example of operations of the electrical power supply system according to the present exemplary modification. FIG. 10 is a flowchart showing an example of operations of the electrical power supply system according to the present exemplary modification. FIG. 11 is a flowchart showing an example of operations of the electrical power supply system according to the present exemplary modification. Operations in relation to pre-charging of the smoothing capacitors 44 and starting the engine 32 are shown in FIG. 10 and FIG. 11. When pre-charging is carried out, all of the contactors 64 that are provided in the disconnection device 62 are set in advance to an ON state, and further, all of the contactors 80 that are provided in the disconnection devices 78 are set in advance to an OFF state.

In step S51, the control unit 92 compares the output voltage of the power storage device 52a and the output voltage of the power storage device 52b. In the case that the output voltage of the power storage device 52b is higher than the output voltage of the power storage device 52a (YES in step S51), the process transitions to step S52. In the case that the output voltage of the power storage device 52b is less than or equal to the output voltage of the power storage device 52a (NO in step S51), the process transitions to step S60.

In step S52, the control unit 92 sets the reverse flow allowing element 74a that is provided in the reverse flow prevention device 70a to the ON state. Thereafter, the process transitions to step S53.

In step S53, the control unit 92 boosts the DC electrical power that is output from the power storage devices 53 by means of the voltage conversion devices 47, and supplies the DC electrical power that was boosted to the electrical power supply circuits 38. The timing t31 shown in FIG. 11 is a timing at which the boosting by the voltage conversion devices 47 is started. The target output voltage of the voltage conversion devices 47 is set to be equal to the output voltage of the power storage device 52b. Apart from the fact that the electrical current limiting function is provided in the voltage conversion devices 47, since the smoothing capacitors 44 have a certain amount of capacitance, the voltage of the smoothing capacitors 44 gradually rise. Due to the electrical current limitation, the smoothing capacitors 44 are charged with a constant electrical current. Since the voltage conversion devices 47 are connected to the electrical power supply circuits 38 at a position between the electrical power generating device 30 and the disconnection devices 62, pre-charging is carried out all at once with respect to the smoothing capacitors 44aa to 44ac, the smoothing capacitors 44ba to 44bc, and the smoothing capacitor 44d. Thereafter, the process transitions to step S54.

In step S54, the determination unit 90 determines whether or not the difference between the voltage of the smoothing capacitors 44ba to 44bc and the output voltage of the power storage device 52b is less than or equal to the predetermined difference threshold value. The voltage of the smoothing capacitors 44ba to 44bc can be grasped based on the measurement result obtained by a non-illustrated voltage sensor that serves to measure the voltage at the cathode of the reverse flow prevention elements 72. In the case that the difference between the voltage of the smoothing capacitors 44ba to 44bc and the output voltage of the power storage device 52b is greater than the predetermined difference threshold value (NO in step S54), step S54 is repeated. In the case that the difference between the voltage of the smoothing capacitors 44ba to 44bc and the output voltage of the power storage device 52b is less than or equal to the predetermined difference threshold value (YES in step S54), the process transitions to step S55.

In step S55, the control unit 92 connects the power storage device 52b to the electrical power supply circuit 38b. The timing t32 shown in FIG. 11 is a timing at which all of the contactors 80 that are provided in the disconnection device 78b are placed in an ON state. Thereafter, the process transitions to step S56.

In step S56, the control unit 92 changes the target output voltage of the voltage conversion devices 47 to be equal to the output voltage of the power storage device 52a. The timing t33 shown in FIG. 11 is a timing at which the target output voltage of the voltage conversion devices 47 is changed to be equal to the output voltage of the power storage device 52a. Since the output voltage of the power storage device 52a is lower than the output voltage of the power storage device 52b, the voltage of the smoothing capacitors 44aa to 44ac and 44d gradually decreases accompanying the change in the target output voltage of the voltage conversion devices 47. Since the flowing of the electrical current from the side of the load devices 42ba to 42bc to the side of the electrical power generating device 30 is prevented by the reverse flow prevention device 70b, the voltage of the smoothing capacitors 44ba to 44bc does not change. Thereafter, the process transitions to step S57.

In step S57, the determination unit 90 determines whether or not the difference between the voltage of the smoothing capacitors 44aa to 44ac and 44d and the output voltage of the power storage device 52a is less than or equal to the difference threshold value. In the case that the difference between the voltage of the smoothing capacitors 44aa to 44ac and 44d and the output voltage of the power storage device 52a is greater than the predetermined difference threshold value (NO in step S57), step S57 is repeated. In the case that the difference between the voltage of the smoothing capacitors 44aa to 44ac and 44d and the output voltage of the power storage device 52a is less than or equal to the predetermined difference threshold value (YES in step S57), the process transitions to step S58.

In step S58, the control unit 92 connects the power storage device 52a to the electrical power supply circuit 38a. The timing t34 shown in FIG. 11 is a timing at which all of the contactors 80 that are provided in the disconnection device 78a are placed in an ON state. Thereafter, the process transitions to step S59.

In step S59, the control unit 92 brings the voltage boosting by the voltage conversion devices 47 to an end. The timing t35 shown in FIG. 11 is a timing at which the boosting by the voltage conversion devices 47 comes to an end. Thereafter, the process transitions to step S68.

As noted previously, in the case that the output voltage of the power storage device 52b is less than or equal to the output voltage of the power storage device 52a (NO in step S51), the process transitions to step S60. In step S60, the control unit 92 places the reverse flow allowing element 74b in an ON state. Thereafter, the process transitions to step S61.

In step S61, the control unit 92 boosts the DC electrical power that is output from the power storage devices 53 by means of the voltage conversion devices 47, and supplies the DC electrical power that was boosted to the electrical power supply circuits 38. The target output voltage of the voltage conversion devices 47 is set to be equal to the output voltage of the power storage device 52a. Apart from the fact that the electrical current limiting function is provided in the voltage conversion devices 47, since the smoothing capacitors 44 have a certain amount of capacitance, the voltage of the smoothing capacitors 44 gradually rise. Due to the electrical current limitation, the smoothing capacitors 44 are charged with a constant electrical current. Since the voltage conversion devices 47 are connected to the electrical power supply circuits 38 at a position between the electrical power generating device 30 and the disconnection devices 62, pre-charging is carried out all at once with respect to the smoothing capacitors 44aa to 44ac, the smoothing capacitors 44ba to 44bc, and the smoothing capacitor 44d. Thereafter, the process transitions to step S62.

In step S62, the determination unit 90 determines whether or not the difference between the voltage of the smoothing capacitors 44aa to 44ac and the output voltage of the power storage device 52a is less than or equal to the predetermined difference threshold value. In the case that the difference between the voltage of the smoothing capacitors 44aa to 44ac and the output voltage of the power storage device 52a is greater than the predetermined difference threshold value (NO in step S62), step S62 is repeated. In the case that the difference between the voltage of the smoothing capacitors 44aa to 44ac and the output voltage of the power storage device 52a is less than or equal to the predetermined difference threshold value (YES in step S62), the process transitions to step S63.

In step S63, the control unit 92 connects the power storage device 52a to the electrical power supply circuit 38a. Thereafter, the process transitions to step S64.

In step S64, the control unit 92 changes the target output voltage of the voltage conversion devices 47 to be equal to the output voltage of the power storage device 52b. Since the output voltage of the power storage device 52b is lower than the output voltage of the power storage device 52a, the voltage of the smoothing capacitors 44ba to 44bc and 44d gradually decreases accompanying the change in the target output voltage of the voltage conversion devices 47. Since the flowing of the electrical current from the side of the load devices 42aa to 42ac to the side of the electrical power generating device 30 is prevented by the reverse flow prevention device 70a, the voltage of the smoothing capacitors 44aa to 44ac does not change. Thereafter, the process transitions to step S65.

In step S65, the determination unit 90 determines whether or not the difference between the voltage of the smoothing capacitors 44ba to 44bc and 44d and the output voltage of the power storage device 52b is less than or equal to the difference threshold value. In the case that the difference between the voltage of the smoothing capacitors 44ba to 44bc and 44d and the output voltage of the power storage device 52b is greater than the predetermined difference threshold value (NO in step S65), step S65 is repeated. In the case that the difference between the voltage of the smoothing capacitors 44ba to 44bc and 44d and the output voltage of the power storage device 52b is less than or equal to the predetermined difference threshold value (YES in step S65), the process transitions to step S66.

In step S66, the control unit 92 connects the power storage device 52b to the electrical power supply circuit 38b. Thereafter, the process transitions to step S67.

In step S67, the control unit 92 brings the voltage boosting by the voltage conversion devices 47 to an end. Thereafter, the process transitions to step S68.

In step S68, the control unit 92, using the electrical power that is supplied from the power storage devices 52, starts the engine 32 that is connected to the generator 34 that is provided in the electrical power generating device 30. In the case that the output voltage of the power storage device 52a is lower than the output voltage of the power storage device 52b, the engine 32 is started using the electrical power that is supplied from the power storage device 52a. In the case that the output voltage of the power storage device 52b is lower than the output voltage of the power storage device 52a, the engine 32 is started using the electrical power that is supplied from the power storage device 52b. In this manner, the process shown in FIG. 10 comes to an end.

In this manner, the DC electrical power that is boosted by the voltage conversion devices 47 may be supplied to the electrical power supply circuits 38 at a position between the electrical power generating device 30 and the disconnection devices 62.

Concerning the above-described embodiment, the following supplementary notes are further disclosed.

### Supplementary Note 1

The electrical power supply system (26) of the present disclosure comprises the first electrical power supply circuit (38a) that supplies the DC electrical power that is output from the electrical power generating device (30) to the first load devices (42a to 42c), the first power storage device (52a) that is capable of being connected in parallel with the electrical power generation device to the first electrical power supply circuit, a second power storage device (53a) having a rated output voltage lower than that of the first power storage device, and a first voltage conversion device (47a) that is capable of boosting the DC electrical power that is supplied from the second power storage device and supplying the increased DC electrical power to the first electrical power supply circuit, wherein the electrical power supply system comprises a control unit (92) which, in a state in which the first power storage device is disconnected from the first electrical power supply circuit, by supplying electrical power from the second power storage device to the first electrical power supply circuit via the first voltage conversion device, is capable of executing a charge supply control for supplying an electrical charge to at least one from among the first load device and the electrical power generating device. In accordance with such a configuration, an electrical charge can be supplied via the first voltage conversion device to at least one of the first load device and the electrical power generating device. Since the current limiting function is provided in the voltage conversion devices, an inrush current does not flow into the smoothing capacitors. In accordance with such a configuration, the pre-charging circuit including the pre-charging resistor or the like, which has a comparatively large mass, is not required, and therefore the weight of the electrical power supply system can be reduced. The reduction in the weight of the electrical power supply system can contribute to an increase in the cruising distance of the moving object. In this manner, in accordance with such a configuration, it is possible to provide a satisfactory electrical power supply system.

### Supplementary Note 2

In the electrical power supply system according to Supplementary Note 1, in the charge supply control, the pre-charging of the smoothing capacitor (44a to 44c) that is provided in the first load device, and the pre-charging of the smoothing capacitor (44d) that is provided in the electrical power generating device may be carried out.

### Supplementary Note 3

In the electrical power supply system according to Supplementary Note 2, the electrical power supply system may further comprise the determination unit (90) that determines whether or not the difference between the voltage of the smoothing capacitor provided in the first load device and the output voltage of the first power storage device is less than or equal to a predetermined difference threshold value, and whether or not a difference between the voltage of the smoothing capacitor provided in the electrical power generating device and the output voltage of the first power storage device is less than or equal to the difference threshold value, and in the case it is determined that the difference between the voltage of the smoothing capacitor provided in the first load device and the output voltage of the first power storage device is less than or equal to the difference threshold value, and further, the difference between the voltage of the smoothing capacitor provided in the electrical power generating device and the output voltage of the first power storage device is less than or equal to the difference threshold value, the control unit may terminate the electrical supplying control, and connect the first power storage device to the first electrical power supply circuit, and may start the engine (32) that is connected to the generator (34) provided in the electrical power generating device using the electrical power that is supplied from the first power storage device.

### Supplementary Note 4

In the electrical power supply system according to Supplementary Note 1, the first voltage conversion device may be capable of stepping down the DC electrical power that is supplied from the first electrical power supply circuit, and may supply the DC electrical power that has been stepped down to the second power storage device.

### Supplementary Note 5

In the electrical power supply system according to Supplementary Note 1, there may further be provided the second electrical power supply circuit (38b) that supplies the DC electrical power that is output from the electrical power generating device to the second load device, the third power storage device (52b) that is capable of being connected in parallel with the electrical power generating device to the second electrical power supply circuit, the fourth power storage device (53b) having a rated output voltage lower than that of the third power storage device, and the second voltage conversion device (47b) that is capable of boosting the DC electrical power that is supplied from the fourth power storage device and supplying the increased DC electrical power to the second electrical power supply circuit, the first electrical power supply circuit may be equipped with the first reverse flow prevention device (70a) that is capable of preventing a reverse flowing of electrical current causing electrical power to be supplied from a side of the first load device to a side of the electrical power generating device, the second electrical power supply circuit is equipped with a second reverse flow prevention device (70b) that is capable of preventing reverse flowing of electrical current causing electrical power to be supplied from a side of the second load device to a side of the electrical power generating device, wherein the control unit may execute the charge supply control in a state in which, in the case that the output voltage of the first power storage device is lower than the output voltage of the third power storage device, the first reverse flow prevention device is set to a state in which the reverse flowing of the electrical current in the first electrical power supply circuit is allowed and the second reverse flow prevention device is set to a state in which the reverse flowing of the electrical current in the second electrical power supply circuit is prevented, and the control unit may execute the charge supply control in a state in which, in the case that the output voltage of the third power storage device is lower than the output voltage of the first power storage device, the second reverse flow prevention device is set to a state in which the reverse flowing of the electrical current in the second electrical power supply circuit is allowed and the first reverse flow prevention device is set to a state in which the reverse flowing of the electrical current in the first electrical power supply circuit is prevented.

### Supplementary Note 6

In the electrical power supply system according to Supplementary Note 5, in the case that the output voltage of the first power storage device is lower than the output voltage of the third power storage device, the control unit may terminate the charge supply control and then connect the first power storage device to the first electrical power supply circuit, and may start the engine that is connected to the generator provided in the electrical power generating device using the electrical power that is supplied from the first power storage device, and in the case that the output voltage of the third power storage device is lower than the output voltage of the first power storage device, the control unit may terminate the charge supply control and connect the third power storage device to the second electrical power supply circuit, and may start the engine using the electrical power that is supplied from the third power storage device.

### Supplementary Note 7

The moving object (10) according to the present disclosure is equipped with the electrical power supply system according to any one of Supplementary Notes 1 to 6.

### Supplementary Note 8

The control method according to the present disclosure is a control method for controlling an electrical power supply system, wherein the electrical power supply system comprises a first electrical power supply circuit that supplies a DC electrical power that is output from an electrical power generating device to a first load device, a first power storage device that is capable of being connected in parallel with the electrical power generating device to the first electrical power supply circuit, a second power storage device having a rated output voltage lower than that of the first power storage device, and a first voltage conversion device that is capable of boosting the DC electrical power that is supplied from the second power storage device and supplying the increased DC electrical power to the first electrical power supply circuit, wherein the control method comprising a charge supply control step (S7) of executing, by one or more processors, a charge supply control of supplying electrical power from the second power storage device to the first electrical power supply circuit via the first voltage conversion device in a state in which the first power storage device is disconnected from the first electrical power supply circuit, for supplying an electrical charge to at least one from among the first load device and the electrical power generating device.

### Supplementary Note 9

In the control method according to Supplementary Note 8, in the charge supply control step, pre-charging of the smoothing capacitor that is provided in the first load device, and pre-charging of the smoothing capacitor that is provided in the electrical power generating device may be carried out.

### Supplementary Note 10

In the control method according to Supplementary Note 9, there may further be provided the determination step (S8) of determining whether or not a difference between the voltage of the smoothing capacitor provided in the first load device and the output voltage of the first power storage device is less than or equal to a predetermined difference threshold value, and whether or not a difference between the voltage of the smoothing capacitor provided in the electrical power generating device and the output voltage of the first power storage device is less than or equal to the difference threshold value, and the connecting step (S9) of terminating the charge supply control and connecting the first power storage device to the first electrical power supply circuit, by the one or more processors, in the case it is determined in the determination step that the difference between the voltage of the smoothing capacitor provided in the first load device and the output voltage of the first power storage device is less than or equal to the difference threshold value, and further, the difference between the voltage of the smoothing capacitor provided in the electrical power generating device and the output voltage of the first power storage device is less than or equal to the difference threshold value.

### Supplementary Note 11

In the control method according to claim 10, there may further be provided, after the connecting step, the starting step (S20) of starting, by the one or more processors power storage device, an engine using the electrical power that is supplied from the first power storage device, the engine being connected to the generator that is provided in the electrical power generating device.

### Supplementary Note 12

In the electrical power supply method according to Supplementary Note 10, the electrical power supply system may further comprise the second electrical power supply circuit that supplies the DC electrical power that is output from the electrical power generating device to the second load device, the third power storage device that is capable of being connected in parallel with the electrical power generating device to the second electrical power supply circuit, the fourth power storage device having a rated output voltage lower than that of the third power storage device, and the second voltage conversion device that is capable of boosting the DC electrical power that is supplied from the fourth power storage device and supplying the increased DC electrical power to the second electrical power supply circuit, the first electrical power supply circuit may be equipped with the first reverse flow prevention device that is capable of preventing the reverse flowing of the electrical current causing the electrical power to be supplied from the side of the first load device to the side of the electrical power generating device, and the second electrical power supply circuit may be equipped with the second reverse flow prevention device that is capable of preventing the reverse flowing of the electrical current causing the electrical power to be supplied from the side of the second load device to the side of the electrical power generating device, wherein, in the case that the output voltage of the first power storage device is lower than the output voltage of the third power storage device, the charge supply control step may be executed in which the first reverse flow prevention device is set to a state in which the reverse flowing of the electrical current in the first electrical power supply circuit is allowed, and the second reverse flow prevention device is set to a state in which the reverse flowing of the electrical current in the second electrical power supply circuit is prevented, and in the case that the output voltage of the third power storage device is lower than the output voltage of the first power storage device, the charge supply control step may be executed in which the second reverse flow prevention device is set to a state in which the reverse flowing of the electrical current in the second electrical power supply circuit is allowed and the first reverse flow prevention device is set to a state in which the reverse flowing of the electrical current in the first electrical power supply circuit is prevented.

### Supplementary Note 13

In the electrical power supply method according to Supplementary Note 12, in the case that the output voltage of the first power storage device is lower than the output voltage of the third power storage device, after the charge supply control step is completed, there may further be provided the step by the one or more processors of connecting the first power storage device to the first electrical power supply circuit, and starting an engine connected to a generator provided in the power generation device using the electrical power that is supplied from the first power storage device, and in the case that the output voltage of the third power storage device is lower than the output voltage of the first power storage device, after the charge supply control step is completed, there may further be provided the step by the one or more processors of connecting the third power storage device to the second electrical power supply circuit, and starting an engine by the one or more processors using the electrical power that is supplied from the third power storage device.

### Supplementary Note 14

In the electrical power supply method according to Supplementary Note 12, in the charge supply control step, in a state in which the first power storage device is disconnected from the first electrical power supply circuit, and further, the third power storage device is disconnected from the second electrical power supply circuit, by supplying the electrical power via the first voltage conversion device from the second power storage device to the first electrical power supply circuit and supplying the electrical power via the second voltage conversion device from the fourth power storage device to the second electrical power supply circuit, there may be supplied the electrical charges in the smoothing capacitor provided in each of the electrical power generating device, the smoothing capacitor provided in the first load device, and the smoothing capacitor provided in the second load device; and in the connecting step, the first power storage device may be connected to the first electrical power supply circuit and the third power storage device may be connected to the second electrical power supply circuit.

### Supplementary Note 15

The program of the present disclosure is a program in order to execute the control method according to any one of Supplementary Notes 8 to 14.

### Supplementary Note 16

The storage medium of the present disclosure is a non-transitory storage medium in which the program according to Supplementary Note 15 is stored.

Although concerning the present disclosure, a detailed description thereof has been presented above, the present disclosure is not necessarily limited to the individual embodiments described above. These embodiments may be subjected to various additions, substitutions, modifications, partial deletions and the like, within a range that does not deviate from the essence and gist of the present disclosure, or the spirit of the present disclosure as derived from the contents described in the claims and equivalents thereof. Further, the embodiments can also be implemented together in combination. For example, in the above-described embodiments, the order of each of the operations and the order of each of the processes are illustrated as examples, and the present invention is not necessarily limited to these features. The same also applies to cases in which numerical values or mathematical expressions are used in the description of the aforementioned embodiments.

1. An electrical power supply system, comprising:
a first electrical power supply circuit configured to supply a direct current electrical power that is output from an electrical power generating device to a first load device;
a first power storage device that is connectable in parallel with the electrical power generating device to the first electrical power supply circuit;
a second power storage device having a rated output voltage lower than a rated output of the first power storage device;
a first voltage conversion device configured to boost a direct current electrical power that is supplied from the second power storage device and supply an increased direct current electrical power to the first electrical power supply circuit; and
one or more processors that execute computer-executable instructions stored in a memory;
wherein the one or more processors execute the computer-executable instructions to cause the electrical power supply system to:
execute a charge supply control for supplying an electrical charge to at least one of the first load device or the electrical power generating device in a state in which the first power storage device is disconnected from the first electrical power supply circuit, by supplying the electrical power from the second power storage device to the first electrical power supply circuit via the first voltage conversion device.

2. The electrical power supply system according to claim 1, wherein, in the charge supply control, pre-charging of a smoothing capacitor that is provided in the first load device, and pre-charging of a smoothing capacitor that is provided in the electrical power generating device are carried out.

3. The electrical power supply system according to claim 2, wherein the one or more processors cause the electrical power supply system to:
determine whether or not a difference between a voltage of the smoothing capacitor provided in the first load device and an output voltage of the first power storage device is less than or equal to a predetermined difference threshold value, and whether or not a difference between a voltage of the smoothing capacitor provided in the electrical power generating device and the output voltage of the first power storage device is less than or equal to the difference threshold value;
in the case it is determined that the difference between the voltage of the smoothing capacitor provided in the first load device and the output voltage of the first power storage device is less than or equal to the difference threshold value, and further, the difference between the voltage of the smoothing capacitor provided in the electrical power generating device and the output voltage of the first power storage device is less than or equal to the difference threshold value, terminate the charge supply control, and connect the first power storage device to the first electrical power supply circuit, and start an engine that is connected to a generator provided in the electrical power generating device using electrical power that is supplied from the first power storage device.

4. The electrical power supply system according to claim 1, wherein the first voltage conversion device is configured to step down the direct current electrical power that is supplied from the first electrical power supply circuit and supply the direct current electrical power that has been stepped down to the second power storage device.

5. The electrical power supply system according to claim 1, further comprising:
a second electrical power supply circuit configured to supplies a direct current electrical power that is output from the electrical power generating device to a second load device;
a third power storage device that is connectable in parallel with the electrical power generating device to the second electrical power supply circuit;
a fourth power storage device having a rated output voltage lower than a rated output voltage of the third power storage device; and
a second voltage conversion device configured to boost a direct current electrical power that is supplied from the fourth power storage device and supply an increased direct current electrical power to the second electrical power supply circuit;
the first electrical power supply circuit is equipped with a first reverse flow prevention device configured to prevent reverse flowing of electrical current causing electrical power to be supplied from a side of the first load device to a side of the electrical power generating device;
the second electrical power supply circuit is equipped with a second reverse flow prevention device configured to prevent reverse flowing of electrical current causing electrical power to be supplied from a side of the second load device to a side of the electrical power generating device;
wherein the one or more processors cause the electrical power supply system to:
in the case that an output voltage of the first power storage device is lower than an output voltage of the third power storage device, execute the charge supply control in a state in which the first reverse flow prevention device is set to a state in which reverse flowing of the electrical current in the first electrical power supply circuit is allowed and the second reverse flow prevention device is set to a state in which reverse flowing of the electrical current in the second electrical power supply circuit is prevented; and
in the case that the output voltage of the third power storage device is lower than the output voltage of the first power storage device, execute the charge supply control in a state in which the second reverse flow prevention device is set to a state in which the reverse flowing of the electrical current in the second electrical power supply circuit is allowed and the first reverse flow prevention device is set to a state in which the reverse flowing of the electrical current in the first electrical power supply circuit is prevented.

6. The electrical power supply system according to claim 5, wherein the one or more processors cause the electrical power supply system to:
in the case that the output voltage of the first power storage device is lower than the output voltage of the third power storage device, after the charge supply control is completed, connect the first power storage device to the first electrical power supply circuit, and start an engine that is connected to a generator provided in the electrical power generating device using electrical power that is supplied from the first power storage device; and
in the case that the output voltage of the third power storage device is lower than the output voltage of the first power storage device, after the charge supply control is completed, connect the third power storage device to the second electrical power supply circuit, and start the engine using electrical power that is supplied from the third power storage device.

7. A moving object comprising the electrical power supply system according to claim 1.

8. A control method executed by one or more processors provided in an electrical power supply system, wherein the electrical power supply system comprises:
a first electrical power supply circuit configured to supply a direct current electrical power that is output from an electrical power generating device to a first load device;
a first power storage device that is connectable in parallel with the electrical power generating device to the first electrical power supply circuit;
a second power storage device having a rated output voltage lower than a rated output voltage of the first power storage device;
a first voltage conversion device configured to boost a direct current electrical power that is supplied from the second power storage device and supply an increased direct current electrical power to the first electrical power supply circuit; and
wherein the electrical power supply method comprising:
executing, by one or more processors, a charge supply control of supplying electrical power from the second power storage device to the first electrical power supply circuit via the first voltage conversion device in a state in which the first power storage device is disconnected from the first electrical power supply circuit, for supplying an electrical charge to at least one from among the first load device and the electrical power generating device.

9. The control method according to claim 8, wherein, in the charge supply control, pre-charging a smoothing capacitor that is provided in the first load device, and pre-charging a smoothing capacitor that is provided in the electrical power generating device.

10. The control method according to claim 9, comprising:
determining, by the one or more processors, whether or not a difference between a voltage of the smoothing capacitor provided in the first load device and an output voltage of the first power storage device is less than or equal to a predetermined difference threshold value, and whether or not a difference between a voltage of the smoothing capacitor provided in the electrical power generating device and the output voltage of the first power storage device is less than or equal to the difference threshold value; and
terminating the charge supply control by the one or more processors, and connecting the first power storage device to the first electrical power supply circuit by the one or more processors, in the case it is determined in the determination step that the difference between the voltage of the smoothing capacitor provided in the first load device and the output voltage of the first electrical power storage device is less than or equal to the difference threshold value, and further, the difference between the voltage of the smoothing capacitor provided in the electrical power generating device and the output voltage of the first electrical power storage device is less than or equal to the difference threshold value.

11. The control method according to claim 10, further comprising, after the connecting, starting, by the one or more processors, an engine that is connected to a generator that is provided in the electrical power generating device using electrical power that is supplied from the first power storage device.

12. The electrical power supply method according to claim 10, wherein the electrical power supply system further comprises:
a second electrical power supply circuit configured to supply a direct current electrical power that is output from the electrical power generating device to a second load device;
a third power storage device that is connectable in parallel with the electrical power generating device to the second electrical power supply circuit;
a fourth power storage device having a rated output voltage lower than that of the third power storage device; and
a second voltage conversion device configured to boost a direct current electrical power that is supplied from the fourth power storage device and supply an increased direct current electrical power to the second electrical power supply circuit;
the first electrical power supply circuit is equipped with a first reverse flow prevention device configured to prevent a reverse flowing of electrical current causing electrical power to be supplied from a side of the first load device to a side of the electrical power generating device; and
the second electrical power supply circuit is equipped with a second reverse flow prevention device configured to prevent reverse flowing of electrical current causing electrical power to be supplied from a side of the second load device to a side of the electrical power generating device;
wherein:
in the case that an output voltage of the first power storage device is lower than an output voltage of the third power storage device, the charge supply control is executed in which the first reverse flow prevention device is set to a state in which reverse flowing of the electrical current in the first electrical power supply circuit is allowed, and the second reverse flow prevention device is set to a state in which reverse flowing of the electrical current in the second electrical power supply circuit is prevented; and
in the case that the output voltage of the third power storage device is lower than the output voltage of the first power storage device, the charge supply control is executed in which the second reverse flow prevention device is set to a state in which the reverse flowing of the electrical current in the second electrical power supply circuit is allowed, and the first reverse flow prevention device is set to a state in which the reverse flowing of the electrical current in the first electrical power supply circuit is prevented.

13. The electrical power supply method according to claim 12, further comprising:
in the case that the output voltage of the first power storage device is lower than the output voltage of the third power storage device, after the charge supply control is completed, connecting the first power storage device to the first electrical power supply circuit, and starting an engine connected to a generator provided in the power generation device by the one or more processors using the electrical power that is supplied from the first power storage device; and
in the case that the output voltage of the third power storage device is lower than the output voltage of the first power storage device, after the charge supply control is completed, connecting the third power storage device to the second electrical power supply circuit, and starting the engine by the one or more processors using the electrical power that is supplied from the third power storage device.

14. The electrical power supply method according to claim 12, wherein:
in the charge supply control, in a state in which the first power storage device is disconnected from the first electrical power supply circuit, and further, the third power storage device is disconnected from the second electrical power supply circuit, supplying the electrical power via the first voltage conversion device from the second power storage device to the first electrical power supply circuit and supplying the electrical power via the second voltage conversion device from the fourth power storage device to the second electrical power supply circuit, thereby supplying the electrical charges to each of the smoothing capacitor provided in the electrical power generating device, the smoothing capacitor provided in the first load device, and the smoothing capacitor provided in the second load device; and
in the connecting, connecting the first power storage device to the first electrical power supply circuit and connecting the third power storage device to the second electrical power supply circuit.

15. A non-transitory storage medium in which there is stored a program in order to cause a computer to execute the control method according to claim 8.
